(19) United States
(12) Patent Application Publication
(10) Pub. No.: US 2006/0223493 A1
(43) Pub. Date: Oct. 5, 2006

(54) Method and apparatus for enhancing the survivability of wireless communication systems in response to catastrophic events

(76) Inventor: John F. Freund, Reynoldsburg, OH (US)

Correspondence Address: Lucent Technologies Inc., Docket Administrator - Room 3J-219, 101 Crawfords Corner Road, Holmdel, NJ, 07733-3030, US

(21) Appl. No.: 11/092,117

(22) Filed: Mar. 29, 2005

(51) Int. Cl. H04M 11/04

(52) U.S. Cl. 455/404.2; 455/404.1

(57) ABSTRACT

A method and apparatus for enhancing the survivability of a wireless communications network in response to catastrophic events. The operation of one or more partitions of wireless system components is monitored, and one or more emergency communications are rerouted through the network when one or more of these partitions of wireless system components is determined to be non-operational. In one embodiment of the invention, catastrophic alerting system nodes are associated with and co-located with each of various types of wireless system components, such as, for example, mobile switching centers, base station controllers and base stations, and advantageously identify segments (e.g., partitions of wireless system components) that are out of service. Then, emergency communications (e.g., “911” calls) may be advantageously rerouted through the network when one or more of these partitions of wireless system components is determined to be non-operational.

### FIELD OF THE INVENTION

The present invention relates generally to the field of wireless communications systems and in particular to a method and apparatus for enhancing the survivability of such systems in response to catastrophic events which result, for example, in large outages in cellular networks.

### BACKGROUND OF THE INVENTION

Cellular communications systems are fragile. Many factors contribute to a reliable voice session over a cellular link. Even under the best of circumstances, voice transmission over cellular phones is not quite as good as wired voice calls. Data transmission can be even more susceptible to interference, although protocol implementations help improve transmission quality. Considering all of this, a catastrophic event, like a large-scale disruption in service caused, for example, by a cataclysmic event based in nature or malevolent actions of others, can have a profound affect on the quality of cellular transmissions.

Wired communications systems have distinct standards for reliability. For example, certain standards define requirements for central office equipment in terms of EMI (Electromagnetic Interference) output, and how the cabinets handle disasters, such as fires and earthquakes. While such standards are utilized for wireless systems as well, none of these standards necessarily define or improve the service during severe outages. Instead, they focus on minimizing damage to other equipment in the central office. As more people abandon the wired telephone in favor of a mobile phone, challenges arise to provide the same level of service and give users the protections outlined by “911” and CALEA (Communications Assistance for Law Enforcement Act of 1994) laws.

Consider, for example, the catastrophic outages that occurred in the New York City area after the attacks of Sep. 11, 2001. Cellular towers and communications devices were rendered useless, as they were either destroyed or lost their connection to their peers. This specific problem illustrates the need for a robust system for identifying and managing severe outages in cellular networks.

### SUMMARY OF THE INVENTION

A method and apparatus for enhancing the survivability of a wireless communications network in response to catastrophic events is provided in accordance with the present invention. In particular, the operation of one or more partitions of wireless system components is monitored, and one or more emergency communications are rerouted through the network when one or more of these partitions of wireless system components is determined to be non-operational. In accordance with an illustrative embodiment of the invention, catastrophic alerting system nodes are associated with and co-located with each of various types of wireless system components, such as, for example, mobile switching centers, base station controllers and base stations, and advantageously identify segments (e.g., partitions of wireless system components) that are out of service. Then, emergency communications may be advantageously rerouted through the network when one or more of these partitions of wireless system components is determined to be non-operational.

### BRIEF DESCRIPTION OF THE DRAWINGS

FIG. 1 shows a diagram illustrating the coverage area which might result from a large network outage.

FIG. 2 shows a top down design of the infrastructure of an illustrative traditional cellular communications system.

FIG. 3 shows an example of a conventional cellular communications network environment.

FIG. 4 shows a cellular communications network environment which employs a catastrophic alerting system in accordance with an illustrative embodiment of the present invention.

### DETAILED DESCRIPTION OF THE ILLUSTRATIVE EMBODIMENTS

The basic design of most cellular networks emphasizes the preservation of spectrum. Spectrum allocation amongst wireless carriers is limited. In fact, each U.S. wireless carrier routinely spends millions of dollars to acquire licenses from the FCC to operate its mobile phones. Many products have been established in the wireless arena that help to reduce the load on spectrum and allow greater reuse. And typically, adjacent cells are prohibited from using the same spectrum, as it would cause problems during handoff. Earlier implementations of cellular air interface technologies such as FDMA (Frequency Division Multiple Access) and TDMA (Time Division Multiple Access), each fully familiar to those of ordinary skill in the art, were restricted by this limitation. CDMA (Code Division Multiple Access) technologies, including the newer CDMA2000 and UMTS (Universal Mobile Telecommunications System), on the other hand, utilize a different methodology. In particular, as is also familiar to those of ordinary skill in the art, CDMA based communications are XOR'ed via a code and then transmitted on a particular frequency. This advantageously isolates one communication from another in a different way than previously used with frequency or time division. Such code division techniques advantageously allow many handsets to use the same frequency to communicate without interfering. In theory, the entire spectrum can be reused in each and every adjacent cell. A second major feature of CDMA networks is power conservation. Base stations control the power output of the handsets. This is a different model than previously used, where the handset power control was static. This allows the network to control whose signals are amplified and whose are not. The battery life of the handsets is increased greatly because of this.

These two features of CDMA networks are helpful in providing services to end users, but do not aid in creating a resilient network. If a large network outage occurs, such as, for example, one which consumes several blocks of coverage, nobody in the epicenter of the outage will be able to find a cell to connect to in order to make a call. Further, those near the periphery of the outage will find their cell phone competing with countless others for connections in the same area, and in so doing, their batteries will likely be strained.

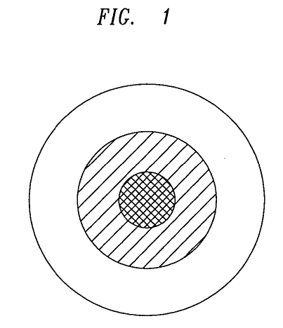

FIG. 1 shows a diagram illustrating the coverage area which might result from a large network outage. In the figure, there is shown a dark central core of an outage. Handsets located in this area will not be able to reach the nearest operational cell tower, which is located in the region represented by the white area outside of the set of concentric circles. However, with the proper power output, handsets and cell towers around the peripheral of the concentric circles may be able to reach the areas shaded with grey. The light grey area adjacent to areas where cell coverage is live will be continuously trying to connect the towers it can reach, competing for coverage with each other and the handsets in the area it was originally designated to service. This creates a problem, as service outages will be expanded beyond what is considered the disaster area.

It is extremely likely that the emergency authorities will be aware of an outage of this size and probably not through the cell phone outages. Physical damage this big will be noticed. The problem is in how the network handles this big of an outage. As a result, competing handsets may not be able to properly notify authorities of specific problem areas, or other relevant information via the 911 system, or any other regular call.

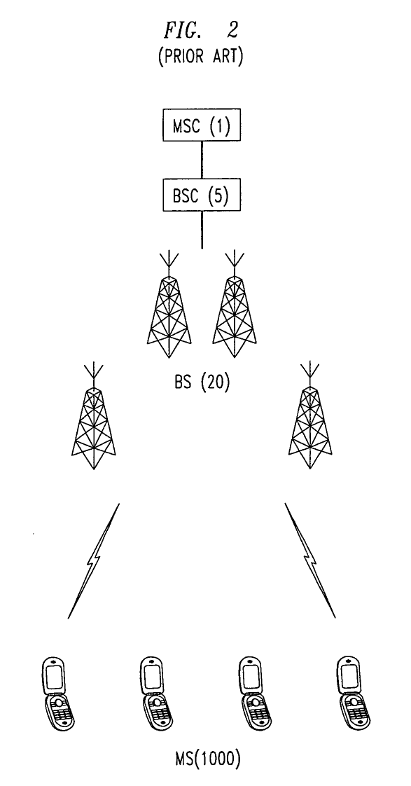

FIG. 2 shows a top down design of the infrastructure of an illustrative traditional cellular communications system. The system consists of a plurality of cells 21 (illustratively 20) containing one base station (BS) per cell. Each of these base stations are controlled by one of a (smaller) plurality of base station controllers (BSC) 22 (illustratively 5). All of the base station controllers link upstream to the system's sole mobile switching center (MSC) 23. FIG. 2 also shows that the metropolitan statistical area (MSA) is comprised of a large number of cellular phones or mobile stations (MS) 24 (illustratively 1000).

In accordance with the illustrative embodiment of the present invention, two methodologies are advantageously employed to increase the survivability of the network: 1) the use of an inverted tree structure for alerting and reporting outages, and 2) the use of ad-hoc routing for prioritizing emergency calls. Inverted tree structures are well known to those of ordinary skill in the art. For example, such structures are used throughout the Internet and in numerous computer science implementations. For example, such structures are the basis for the robust DNS (domain name server) system used in the Internet, as well as for numerous directory services architectures.

Specifically, in accordance with the illustrative embodiment of the present invention, a Catastrophic Alerting System (CAS) is comprised of a series of catastrophe sensors, advantageously fashioned in an inverted tree structure. These act as a control monitor for their segmented portion of the cellular communications network. They may advantageously be co-located with the base stations, base station controllers, and mobile switching centers in the network. Moreover, they will each advantageously have links to neighboring (i.e., “horizontally” adjacent) sensors as well as to upstream and downstream (i.e., “vertically” adjacent) sensors.

In accordance with the illustrative embodiment of the present invention, when an outage occurs, the network advantageously reallocates spectrum that is in use in the core outage area to the nodes in the surrounding area to help alleviate stress. In particular, any of a number of conventional frequency allocation protocols, traditionally used for purposes of congestion control and fully familiar to those skilled in the art, may be advantageously employed. In addition, call routing and completion may be offloaded to a neighboring mobile switching center if it is determined to be advantageous to do so.

Moreover, in accordance with the illustrative embodiment of the present invention, the system may be configured to advantageously cooperate with other service providers. Specifically, the root of the inverted tree for a single service provider may be configured to be a node in a larger (e.g., “nation-wide”) cellular catastrophe system. Then, in the event of a catastrophe, the frequencies and resources of multiple systems may be advantageously shared to aid emergency personnel.

In accordance with one illustrative embodiment of the present invention, in addition to the Catastrophic Alerting System described above, mobile stations are advantageously configured to cooperate as ad-hoc nodes in the event of an emergency. For 911 calls in the dark outage area of FIG. 1, for example, instead of the call being blocked, nearby cells will advantageously act as relay hosts for the sending mobile stations. In accordance with this illustrative embodiment, the cells relay the call to the nearest tower, or to the nearest other cell which advertises a fast route to the nearest tower. Any one of a number of conventional routing protocols, fully familiar to those skilled in the art, may be utilized to exact this configuration. Since power consumption is a critical issue in this application, it may be advantageous to restrict the use of this technique to 911 calls. (If all calls were to be relayed in this fashion, then the battery of a cell might drain even if it were not in use, due to neighbors relaying calls.) Note, however, that in catastrophe situations, 911 calls should not be ignored, and thus, in accordance with the principles of the present invention and this illustrative embodiment thereof, will not be. Moreover, as battery life and technology advance with future improvements thereto, the system in accordance with this illustrative embodiment of the present invention may be advantageously utilized to create a combination of client-server styled BS-MS (base station and mobile station) relationships, as well as more ad-hoc MS-MS (mobile station to mobile station) styled communications using, for example, the well-known Bluetooth protocol or similar short range wireless radio transmission technique.

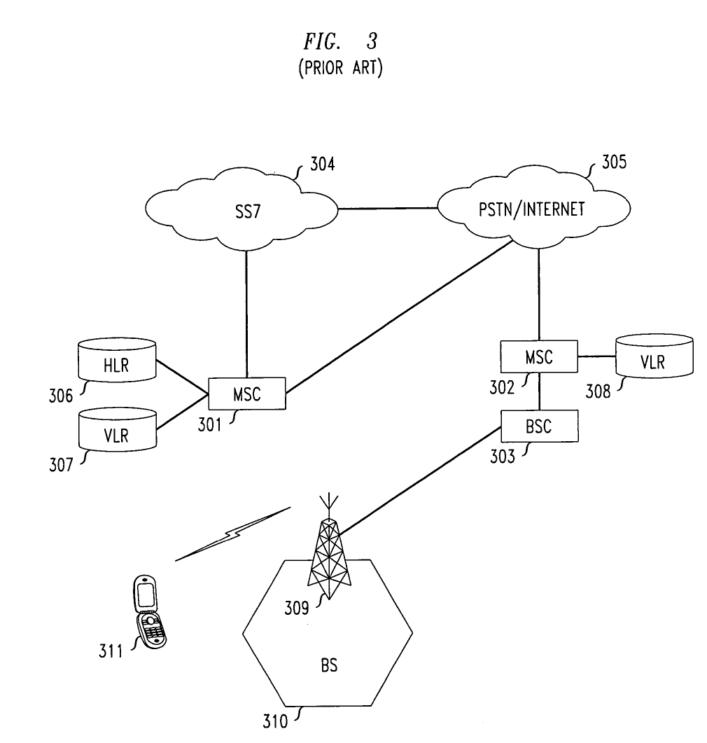

FIG. 3 shows an example of a conventional cellular communications network environment. The conventional environment as shown comprises mobile switching centers 301 and 302, base station controller 303, SS7 (Signaling System 7) out-of-band switching network 304, transportation network 305 comprising, for example, a PSTN (Public Switched Telephone Network) and/or the Internet, HLR (Home Location Register) database 306, VLR (Visiting Location Register) databases 307 and 308, base station (BS) 309 covering communications cell 310, and mobile station (i.e., cellular telephone) 311. (SS7 out-of-band switching networks, transportation networks such as the Public Switched Telephone Network and the Internet, Home Location Register databases, and Visiting Location Register databases, as well as mobile switching centers, base station controllers and base stations, are all fully familiar to those of ordinary skill in the art.)

In normal operation of the conventional network environment of FIG. 3, the mobile switching centers (MSCs) control several Base Station Controllers (BSCs), each of which in turn controls several base stations (BSs). In particular, mobile station 311 communicates with base station 309, which, in turn, communicates with base station controller 303, which, in turn, communicates with mobile switching center 302, which then enables communication throughout transportation network 305 (e.g., a PSTN or the Internet). Note that there is a vertical affinity in the conventional network environment of FIG. 3 in that most links travel vertically to the next higher order network node.

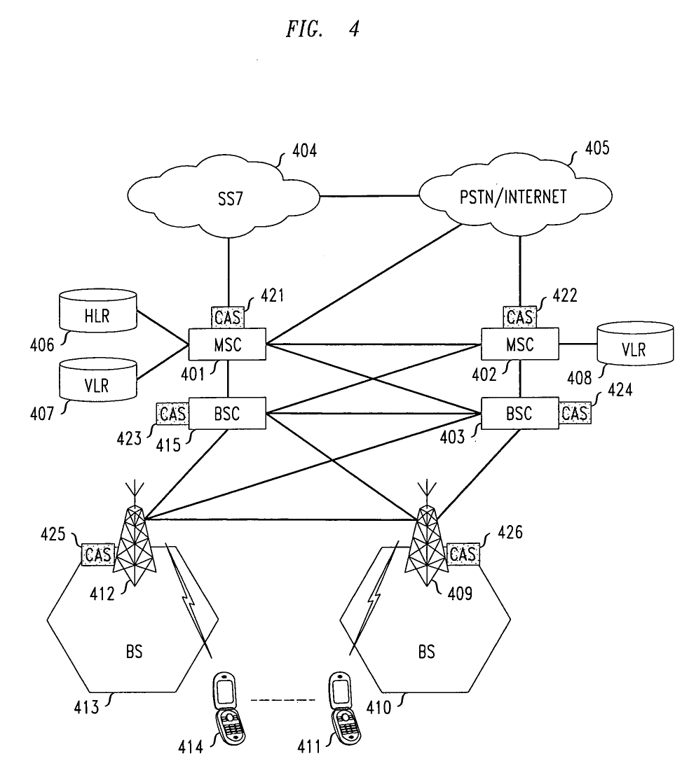

FIG. 4 shows a cellular communications network environment which employs a catastrophic alerting system in accordance with an illustrative embodiment of the present invention. Like a conventional cellular communication network environment such as the example environment of FIG. 3, the illustrative network environment of FIG. 4 comprises mobile switching centers 401 and 402, base station controllers 403 and 415, SS7 (Signaling System 7) out-of-band switching network 404, transportation network 405 comprising, for example, a PSTN (Public Switched Telephone Network) and/or the Internet, HLR (Home Location Register) database 406, VLR (Visiting Location Register) databases 407 and 408, base station (BS) 309 covering communications cell 310 as well as base station (BS) 412 covering communications cell 413, and mobile stations (i.e., cellular telephone) 411 and 414.

In addition, however, in accordance with an illustrative embodiment of the present invention, several additional elements are also advantageously included in the illustrative environment of FIG. 4, most particularly, Catastrophe Alerting System (CAS) nodes 421 through 426. These nodes are illustratively and advantageously associated with and co-located with each mobile switching center, base station controller and base station, as shown in the figure. Moreover, there is the advantageous addition of several connections (both transmission and signaling) to the illustrative design shown in FIG. 4. (The added connections are shown in bold in FIG. 4.) These extra connections advantageously serve as backups in case of severe outages, when such outages are identified by corresponding CAS nodes.

The Catastrophe Alerting System (CAS) nodes serve as monitoring nodes and may, for example, make use of conventional monitoring software such as, for example, monitoring software as the Lucent Navis® Network Fault Management (NFM) Software for Service Providers. An upstream monitoring station running such software may be responsible for the overall health of the network. Each CAS node advantageously monitors downstream health and reports status upstream. If a given node cannot communicate with a downstream node, it is considered unavailable and an alert is advantageously triggered. Each subsequent upstream node can then poll the health of the system through this system.

Then, in accordance with the principles of the present invention, and in accordance with an illustrative embodiment thereof, segments (e.g., partitions of wireless system components) that are out of service are advantageously identified, and a backup link and connection are advantageously activated to help alleviate spikes in call volumes in neighboring cells. Specifically, in accordance with the principles of the present invention, emergency calls (i.e., “911” calls) are also routed specially through the system by being rerouted through the network.

Moreover, in accordance with certain illustrative embodiments of the present invention, the cell phones (i.e., mobile stations 411 and 414) themselves may advantageously have mutual connections to further support emergency (e.g., “911”) calls in the event of BSC and/or MSC failures. In accordance with various such illustrative embodiments of the present invention, mutual connections between cell phones may be advantageously implemented with use of a conventional short range wireless radio transmission technique such as Bluetooth or Wi-Fi (IEEE 802.11), each of which is well known to those skilled in the art. In particular, in such cases and in the event of a catastrophic failure, messages may be advantageously passed from phone to phone until an appropriate upstream connection can be established.

Note that one particular advantage of a system in accordance with the above-described illustrative embodiment of the present invention is that it allows for the sharing of cellular status between service providers. In the case of severe emergencies, it may be necessary for providers to share resources to enable the overall safety of the population. Consider, for example, a situation in which one service provider is extraordinarily taxed by a catastrophe, but another is not. In this case, there may be spectrum that is unable to be utilized by the affected carrier in a particular area. Through a CAS system in accordance with the present invention, messaging may be advantageously routed to other service providers to expand their service by using this additional spectrum. Such techniques may be advantageously utilized within a given service provider's own network as well—namely, if a CAS node of the present invention detects an outage in one area, this spectrum may be advantageously re-used more efficiently in neighboring cells to help manage any increases in demand. The switching of spectrum from one service provider to another or from one cell to a neighboring cell may be accomplished with use of any of a number of conventional protocols and methodologies which will be fully familiar to those skilled in the art.

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

I claim:

1. A method for enhancing the survivability of a wireless communications network in response to catastrophic events, the method comprising the steps of:
monitoring the operation of one or more partitions of wireless system components comprised in said wireless communications network; and
rerouting one or more emergency communications through the network when one or more of said partitions of wireless system components is determined to be non-operational.

2. The method of claim 1 wherein said step of monitoring the operation of one or more partitions of wireless system components is performed by one or more catastrophe alerting system nodes, each of said catastrophe alerting system nodes associated with a corresponding one of said wireless system components.

3. The method of claim 2 wherein each of said catastrophe alerting system nodes is co-located with said corresponding one of said wireless system components.

4. The method of claim 2 wherein each of said catastrophe alerting system nodes comprises monitoring software which determines whether one or more of said wireless system components is operational.

5. The method of claim 1 wherein said wireless system components comprised in said wireless communications network comprise one or more mobile switching centers, one or more base station controllers and one or more base stations.

6. The method of claim 1 wherein said emergency communications comprise “911” calls.

7. The method of claim 1 wherein said wireless communications network comprises a CDMA cellular telephone network.

8. The method of claim 1 wherein said step of rerouting one or more emergency communications through the network when one or more of said partitions of wireless system components is determined to be non-operational comprises rerouting said one or more emergency communications through one or more backup connections which have been added to said wireless communications network.

9. The method of claim 1 further comprising the step of rerouting one or more emergency communications from a first mobile station to a second mobile station, when said first mobile station is unable to directly connect to said wireless communications network.

10. The method of claim 9 wherein said first mobile station and said second mobile station communicate using a short range wireless radio transmission technique.

11. The method of claim 10 wherein said short range wireless radio transmission technique comprises Bluetooth.

12. The method of claim 10 wherein said short range wireless radio transmission technique comprises Wi-Fi.

13. A wireless communications network adapted for enhanced survivability in response to catastrophic events, the wireless communications network comprising:
one or more catastrophe alerting system nodes, each of which monitors the operation of one or more partitions of wireless system components comprised in said wireless communications network; and
one or more backup connections which have been added to said wireless communications network, said one or more backup connections for use in rerouting one or more emergency communications through the network when one or more of said partitions of wireless system components is determined to be non-operational.

14. The wireless communications network of claim 13 wherein each of said catastrophe alerting system nodes is associated with a corresponding one of said wireless system components.

15. The wireless communications network of claim 14 wherein each of said catastrophe alerting system nodes is co-located with said corresponding one of said wireless system components.

16. The wireless communications network of claim 14 wherein each of said catastrophe alerting system nodes comprises monitoring software which determines whether one or more of said wireless system components is operational.

17. The wireless communications network of claim 13 wherein said wireless system components comprised in said wireless communications network comprise one or more mobile switching centers, one or more base station controllers and one or more base stations.

18. The wireless communications network of claim 13 wherein said wireless communications network comprises a CDMA cellular telephone network.

19. The wireless communications network of claim 13 further comprising means for rerouting one or more emergency communications from a first mobile station to a second mobile station, when said first mobile station is unable to directly connect to said wireless communications network.

20. The wireless communications network of claim 19 wherein said means for rerouting one or more emergency communications from a first mobile station to a second mobile station comprises a short range wireless radio transmission technique.
